(19) United States
(12) Patent Application Publication
(10) Pub. No.: US 2010/0077257 A1
(43) Pub. Date: Mar. 25, 2010

(54) METHODS FOR DISASTER RECOVERABILITY TESTING AND VALIDATION

(75) Inventors: Thomas G. Burchfield, Bessemer, AL (US); Randall S. Spell, Douglasville, GA (US)

Correspondence Address: AT&T Legal Department - CC;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/236,966

(22) Filed: Sep. 24, 2008

(51) Int. Cl. G06F 11/00

(52) U.S. Cl. 714/37; 714/E11.144

(57) ABSTRACT

Exemplary methods and computer recovery readiness evaluation process relate to a virtual recovery testing process for Disaster Recovery Plans (DRPs) that can be executed by technical generalists. As such, by implementing the DRP virtual testing process a technical generalist can be charged with the tasks of evaluating and validating documented DRP assumptions, plan execution steps, interoperability dependencies/requirements in addition to the availability of applications, application specific vaulted vital records, and hardware systems that are referenced within the recovery logic of a DRP. Further, the use of established DRP problem management processes to addresses anomalies & deficiencies can also be accomplished.

### BACKGROUND

Exemplary embodiments relate generally to disaster recovery planning, and more particularly, to the virtual testing of disaster recoverability plans.

Disaster recovery is the process of reinstituting access to data, application, and hardware systems that are critical to resuming business operations in the wake of a disaster that has disrupted normal business operations. A Disaster Recovery Plan should include information that not only pertains to the resumption of normal systematic operations, but should also address any sudden or unexpected key personnel losses. Therefore, an effective Disaster Recovery Plan should take into account that the individual that is charged with resuming normal operation may not be a technical specialist in the field he/she is performing recovery operations within. In some instances a business entity may elect not to obtain Disaster Recovery Plan testing or recoverability hardware due to the high cost of acquisition. While the business accepts the risk of longer recovery time objectives associated with this decision, the Disaster Recovery Plans for such testing applications must be executable by available human resources and the vital recovery records must be available for use in the event of a disaster.

### BRIEF SUMMARY

Exemplary embodiments include a method for the testing of disaster recoverability framework protocols within a computing system environment. The method comprises initially retrieving a disaster recovery plan, wherein the disaster recovery plan comprises data restoration logic that is associated with at least one data recovery activity. The disaster recovery plan is analyzed in order to identify any backup data content, application, and hardware resources that are comprised within computing systems that are referenced within the disaster recovery plan. The method also comprises identifying a segment of the disaster recovery plan for evaluation, polling any hardware resources that have been identified in order to determine if the hardware resources are available, and determining the requirements that are necessitated for the recovery of the identified application resources.

The method yet further comprises evaluating the backup data content, application, and hardware resources in accordance with an identified segment of the disaster recovery plan. The evaluation of the backup data content, application, and hardware resources is compared to the data restoration logic of the disaster recovery plan, and thereafter error anomalies between the data restoration logic of the identified segment of the disaster recovery plan and the evaluation of the backup data content, application, and hardware resources are identified.

Additional exemplary embodiments include a computer recovery readiness evaluation process that includes a computer readable medium useable by a processor, the medium having stored thereon a sequence of instructions which, when executed by the user, tests the disaster recoverability framework protocols of a disaster recovery plan by initially retrieving a disaster recovery plan, wherein the disaster recovery plan comprises data restoration logic that is associated with at least one data recovery activity. The disaster recovery plan is analyzed in order to identify any backup data content, application, and hardware resources that are comprised within computing systems that are referenced within the disaster recovery plan. The computer recovery readiness evaluation process also performs the operation of identifying a segment of the disaster recovery plan for evaluation, polling any hardware resources that have been identified in order to determine if the hardware resources are available, and determining an requirements that are necessitated for the recovery of the identified application resources.

The computer recovery readiness evaluation process yet further performs the operation of evaluating the backup data content, application, and hardware resources in accordance with an identified segment of the disaster recovery plan. The evaluation of the backup data content, application, and hardware resources is compared to the data restoration logic of the disaster recovery plan, and thereafter error anomalies between the data restoration logic of the identified segment of the disaster recovery plan and the evaluation of the backup data content, application, and hardware resources are identified.

Other methods, and/or computer recovery readiness evaluation processes according to embodiments will be or become apparent to one with skill in the art upon review of the following drawings and detailed description. It is intended that all such additional systems, methods, and/or computer recovery readiness evaluation processes be included within this description, be within the scope of the exemplary embodiments, and be protected by the accompanying claims.

### BRIEF DESCRIPTION OF DRAWINGS

Referring now to the drawings wherein like elements are numbered alike in the several FIGURES:

FIG. 1 is a diagram illustrating key components that are to be available for the logical testing of a Disaster Recovery Plan in accordance with exemplary embodiments of the present invention;

FIG. 2 is a flow diagram detailing a methodology for the logical testing of a Disaster Recovery Plan in accordance with exemplary embodiments of the present invention; and

FIG. 3 illustrates an example of a computer having elements that may be used in implementing exemplary embodiments.

The detailed description explains the exemplary embodiments, together with advantages and features, by way of example with reference to the drawings.

### DETAILED DESCRIPTION OF EXEMPLARY EMBODIMENTS

One or more exemplary embodiments are described below in detail. The disclosed embodiments are intended to be illustrative only since numerous modifications and variations therein will be apparent to those of ordinary skill in the art.

Exemplary embodiments provide standardized evaluation processes and criteria that can be utilized to evaluate the recoverability of system applications for which testing hardware is not available. The exemplary embodiments also enable Disaster Recovery Plans (DRPs) to be drafted in such a way as to be executable by technical generalists within a field-technical generalist being personnel who are competent in the general operation of computing systems. As such, a technical generalist can implement exemplary embodiments and accomplish the goals of the presented methodology without the need for assistance from personnel intimately familiar with specific applications.

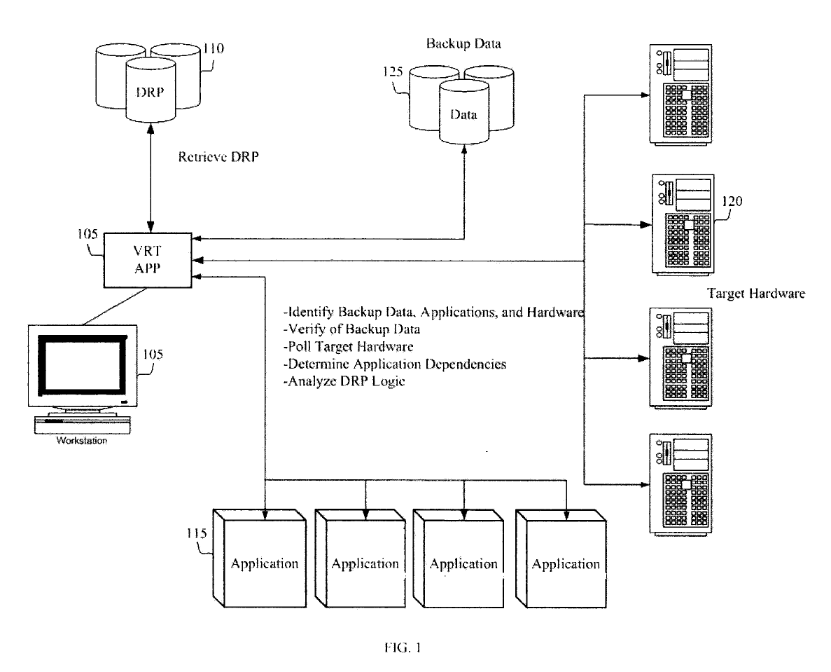

FIG. 1 is a diagram illustrating components that are available for the logical testing of a DRP in accordance with exemplary embodiments. According to exemplary embodiments, a user of a computer workstation 105 may perform virtual recovery testing (VRT) in the event that testing hardware is not available for testing disaster recovery. The computer workstation 105 may include hardware and software elements for assisting a user of the workstation in conducting virtual recovery testing, e.g., components for presenting a graphical user interface. The computer workstation 105 may also include additional hardware and software elements of the types conventionally included in personal computers, such as an operating system, but these are not shown for purposes of clarity.

According to exemplary embodiments, VRT is the full technical review of any application DRP that cannot be unit tested within a Disaster Recovery (DR) environment due to hardware and/or infrastructure constraints. For example, in some instances, a business enterprise may elect not to procure DR testing or recoverability hardware (e.g., due to the high cost of acquisition for a DR testing application or DR recoverability hardware components, etc.). While the business enterprise may accept the potential risk of incurring longer recovery time objectives that are due to the decision not to procure a DR testing application or DR recoverability hardware, DR plan for the business enterprise's applications must be executable by a DR specialist and the vital records of the business enterprise must be available for use in the event of a disaster. Therefore, the exemplary embodiments of the VRT are configured to ensure that a DRP is executable and that any required vital records are available for the recovery process.

When conducting a VRT, each section of a DRP may need to be evaluated for content and execution validity from a unit testing perspective by personnel that are proficient in the computing platform operating system and database of a recovery environment but not intimately familiar with the production application itself. In accordance with exemplary embodiments, the VRT process includes the testing of the logic of all recovery activities that are documented within a DRP in addition to determining the availability of the vital records (backup data) that will be required for systematic recovery at an offsite recovery location. Further, all documented DRP assumptions, plan execution steps, interoperability dependencies/requirements, and the availability of application specific vaulted vital records may be evaluated and validated. As a result, any anomalies or deficiencies are documented and reported.

As shown in FIG. 1, at least one DRP is stored in a dedicated database storage device 110. A DRP that is targeted for testing may be retrieved via the workstation 105, responsive to input from a user. Further applications 115, hardware 120, and vital records (backup data) 125 that have been identified and targeted for testing are also illustrated.

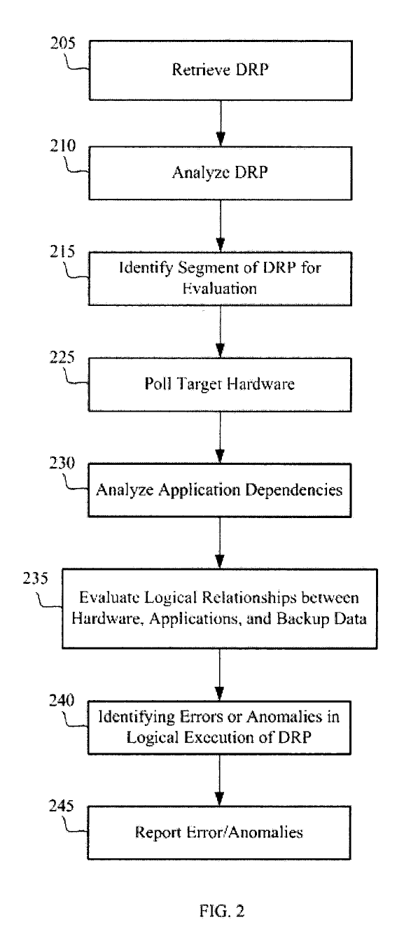

FIG. 2 illustrates a method for disaster recovery testing according to an exemplary embodiment. At step 205 a DRP is retrieved from the storage device 110 via a workstation 105. The DRP comprises data restoration logic that is associated with at least one data recovery activity that is to be simulated within the VRT computer recovery readiness evaluation process 105. At step 210 the DRP is analyzed as a function of the VRT computer recovery readiness evaluation process 105 in order to identify the backup data content 125, application 115, and hardware 120 resources comprised within computing systems that are referenced within the disaster recovery plan.

At step 215, a segment of the DRP is selected for evaluation by a workstation 106 operator, and the selection information is input to the VRT computer recovery readiness evaluation process 105. At step 225 the hardware 120 resources that have been identified within the DRP by the VRT computer recovery readiness evaluation process 105 are polled as a function of the VRT computer recovery readiness evaluation process 105 in order to determine if the hardware 120 resources are available. At step 230 the VRT computer recovery readiness evaluation process 105 determines the requirements that will be necessitated for the recovery of the application 115 resources that have identified within the DRP by evaluating the documented assumptions, plan execution steps, interoperability dependencies/requirements of the DRP. Additionally, the availability of backup data content 125 identified within the DRP (the availability of application specific backup data content) is determined and validated by the VRT computer recovery readiness evaluation process 105 at this time. Within further exemplary embodiments the determining of the availability of identified backup data content further comprises evaluating the availability of the backup data content 125 that is associated with the DRP that will be required for a recovery operation that is to be performed at a predetermined remote location.

At step 235 the backup data content, application, and hardware resources are evaluated by the VRT computer recovery readiness evaluation process 105 in accordance with the identified recovery logic that is included in the segment of the DRP that is being evaluated. Further, all suppositions that are documented within the DRP in addition to recovery operation execution steps that are documented within the DRP are evaluated and validated. Yet further, all the backup data content 125, application 115, and hardware 120 resource interoperability dependencies are evaluated and validated. The analytical evaluation results of the backup data content 125, application 115, and hardware 120 resources are compared to the data restoration logic as detailed within the disaster recovery plan. At step 240 any error anomalies that exist between the data restoration logic of the identified segment of the disaster recovery plan, and the evaluation of the backup data content 125, application 115, and hardware 120 resources are documented and reported to the workstation 106 operator (step 240). The resulting VRT computer recovery readiness evaluation process 105 DRP analytical evaluation results can be displayed to the workstation 106 operator or delivered to another application for further processing.

As mentioned above, the VRT process of the exemplary embodiments can be executed by technical generalists. As such, the technical generalist can be charged with the tasks of evaluating and validating documented DRP assumptions, plan execution steps, interoperability dependencies/requirements and the availability of application specific vaulted vital records. Further, the use of established DR problem management processes to addresses anomalies & deficiencies can also be accomplished.

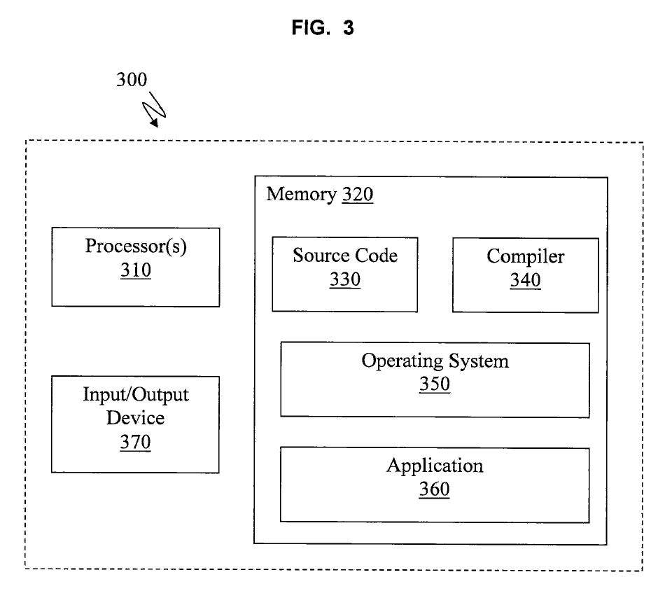

FIG. 3 illustrates an example of a computer 300 having elements that may be used in implementing exemplary embodiments. The computer 300 includes, but is not limited to, PCs, workstations, laptops, PDAs, palm devices, servers, mobile devices, data storage systems, and the like. The computer 300 may include a processor 310, memory 320, and one or more input and/or output (I/O) 370 devices (or peripherals) that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

According to exemplary embodiments, the processor 310 is a hardware device for executing software that can be stored in the memory 320. The processor 310 can be virtually any custom made or commercially available processor, a central processing unit (CPU), a data signal processor (DSP), or an auxiliary processor among several processors associated with the computer 300, and the processor 310 may be a semiconductor based microprocessor (in the form of a microchip) or a macroprocessor.

The memory 320 can include any one or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 320 may incorporate electronic, magnetic, optical, and/or other types of storage media. Note that the memory 320 can have a distributed architecture, where various components are situated remote from one another, but can be accessed by the processor 310.

The software in the memory 320 may include one or more separate programs, each of which comprises an ordered listing of executable instructions for implementing logical functions. In the example illustrated in FIG. 3, the software in the memory 320 includes a suitable operating system (O/S) 350, compiler 340, source code 330, and an application 360 of the exemplary embodiments.

The operating system 350 controls the execution of other computer programs, and provides scheduling, input-output control, file and data management, memory management, and communication control and related services. It is contemplated by the inventors that the application 360 for implementing exemplary embodiments is applicable on all other commercially available operating systems.

The application 360 may be a source program, executable program (object code), script, or any other entity comprising a set of instructions to be performed. When a source program is to be executed, then the program is usually translated via a compiler (such as the compiler 340), assembler, interpreter, or the like, which may or may not be included within the memory 320, so as to operate properly in connection with the O/S 350. Furthermore, the application 360 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O 370 devices may include input devices such as, for example but not limited to, a mouse, keyboard, scanner, microphone, etc. Furthermore, the I/O 370 devices may also include output devices, for example but not limited to, a printer, display, etc. Also, the I/O 370 devices may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc.

When the computer 300 is in operation, the processor 310 is configured to execute software stored within the memory 320, to communicate data to and from the memory 320, and to generally control operations of the computer 300 pursuant to the software. The application 360 and the O/S 350 are read, in whole or in part, by the processor 310, perhaps buffered within the processor 310, and then executed.

When the application 360 is implemented in software, it should be noted that the application 360 can be stored on virtually any computer readable medium for use by or in connection with any computer related system or method. In the context of this document, a computer readable medium may be an electronic, magnetic, optical, or other physical device or means that can contain or store a computer program for use by or in connection with a computer related system or method.

The application 360 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory.

In exemplary embodiments, where the application 360 is implemented in hardware, the application 360 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Further, one or more applications 360 may be configured to implement various operations and processes of exemplary embodiments discussed herein. For example, the application 360 may be configured to implement the VRT computer recovery readiness evaluation process, methods for disaster recovery testing, data restoration logic, etc., in accordance with exemplary embodiments.

As described above, the exemplary embodiments can be in the form of computer-implemented processes and apparatuses for practicing those processes. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes an apparatus for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an apparatus for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A method for the testing of disaster recoverability framework protocols within a computing system environment, the method comprising:
analyzing a disaster recovery plan including data restoration logic that is associated with at least on data recovery activity in order to identify backup data content, application, and hardware resources comprised within computing systems that are referenced within the disaster recovery plan;
identifying a segment of the disaster recovery plan for evaluation;
polling the identified hardware resources to determine if the hardware resources are available;
determining requirements for the recovery of the identified application resources;
evaluating the backup data content, application, and hardware resources in accordance with the identified segment of the disaster recovery plan;
comparing the evaluation of the backup data content, application, and hardware resources to the data restoration logic of the disaster recovery plan; and
identifying error anomalies between the data restoration logic of the identified segment of the disaster recovery plan and the evaluation of the backup data content, application, and hardware resources.

2. The method of claim 1, further comprising determining the availability of the identified backup data content.

3. The method of claim 2, where in response to the identification of recovery operation execution anomalies between the data restoration logic of the identified segment of the disaster recovery plan and the evaluation of the backup data content, application, and hardware resources, an error report is generated detailing the occurrence of any error anomaly.

4. The method of claim 3, further comprising evaluating the backup data content, application, and hardware resources in accordance with the data restoration logic of all of the data recovery activities that are comprised within the disaster recovery plan.

5. The method of claim 4, wherein all suppositions that are documented within the disaster recovery plan are evaluated and validated.

6. The method of claim 5, wherein all recovery operation execution steps that are documented with the disaster recovery plan are evaluated and validated.

7. The method of claim 6, wherein all backup data content, application, and hardware resource interoperability dependencies are evaluated and validated.

8. The method of claim 7, wherein the availability of application specific backup data content is determined.

9. The method of claim 4, wherein determining the availability of the identified backup data content further comprises evaluating the availability of the backup data content that is associated with the disaster recovery plan that will be required for a recovery operation that is to be performed at a predetermined remote location.

10. A computer recovery readiness evaluation process that includes a computer readable medium useable by a processor, the medium having stored thereon a sequence of instructions which, when executed by the user, tests the disaster recoverability framework protocols of a disaster recovery plan by:
analyzing a disaster recovery plan including data restoration logic that is associated with at least one data recovery activity in order to identify backup data content, application, and hardware resources comprised within computing systems that are referenced within the disaster recovery plan;
receiving input identifying a segment of the disaster recovery plan for evaluation;
polling the identified hardware resources to in order to determine if the hardware resources are available;
determining requirements for the recovery of the identified application resources;
evaluating the backup data content, application, and hardware resources in accordance with the identified segment of the disaster recovery plan;
comparing the evaluation of the backup data content, application, and hardware resources to the data restoration logic of the disaster recovery plan; and
identifying error anomalies between the data restoration logic of the identified segment of the disaster recovery plan and the evaluation of the backup data content, application, and hardware resources.

11. The computer recovery readiness evaluation process of claim 10, further comprising determining the availability of the identified backup data content.

12. The computer recovery readiness evaluation process of claim 11, where in response to the identification of recovery operation execution anomalies between the data restoration logic of the identified segment of the disaster recovery plan and the evaluation of the backup data content, application, and hardware resources an error report is generated detailing the occurrence of any error anomaly.

13. The computer recovery readiness evaluation process of claim 12, further comprising evaluating the backup data content, application, and hardware resources in accordance with the data restoration logic of all of the data recovery activities that are comprised within the disaster recovery plan.

14. The computer recovery readiness evaluation process of claim 13, wherein all suppositions that are documented within the disaster recovery plan are evaluated and validated.

15. The computer recovery readiness evaluation process of claim 14, wherein all recovery operation execution steps that are documented with the disaster recovery plan are evaluated and validated.

16. The computer recovery readiness evaluation process of claim 15 wherein all backup data content, application, and hardware resource interoperability dependencies are evaluated and validated.

17. The computer recovery readiness evaluation process of claim 16, wherein the availability of application specific backup data content is determined.

18. The computer recovery readiness evaluation process of claim 14, wherein the determining of the availability of the identified backup data content further comprises evaluating the availability of the backup data content that is associated with the disaster recovery plan that will be required for a recovery operation that is to be performed at a predetermined remote location.

19. A method for the testing of disaster recoverability framework protocols within a computing system environment, the method comprising:
analyzing a disaster recovery plan including data restoration logic that is associated with at least one data recovery activity in order to identify backup data content, application, and hardware resources comprised within computing systems that are referenced within the disaster recovery plan;
identifying a segment of the disaster recovery plan for evaluation;
polling the identified hardware resources to determine if the hardware resources are available;
determining requirements for the recovery of the identified application resources;
evaluating the backup data content, application, and hardware resources in accordance with the identified segment of the disaster recovery plan;
comparing the evaluation of the backup data content, application, and hardware resources to the data restoration logic of the disaster recovery plan;
identifying error anomalies between the data restoration logic of the identified segment of the disaster recovery plan and the evaluation of the backup data content, application, and hardware resources; and
determining the availability of the identified backup data content.

20. The method of claim 19, where in response to the identification of recovery operation execution anomalies between the data restoration logic of the identified segment of the disaster recovery plan and the evaluation of the backup data content, application, and hardware resources, an error report is generated detailing the occurrence of any error anomaly.
